(19) United States
(12) Patent Application Publication
(10) Pub. No.: US 2024/0069170 A1
(43) Pub. Date: Feb. 29, 2024

(54) SMALL APERTURE OPTICAL PERISCOPE FOR LIDAR

(71) Applicant: LUMINAR TECHNOLOGIES, INC., Orlando, FL (US)

(72) Inventors: Daniel Joseph KLEMME, Robbinsdale, MN (US); Daniel Aaron MOHR, St. Paul, MN (US)

(21) Appl. No.: 18/333,435

(22) Filed: Jun. 12, 2023

Related U.S. Application Data
(60) Provisional application No. 63/373,678, filed on Aug. 26, 2022.

(51) Int. Cl. G01S 7/481

(52) U.S. Cl. CPC G01S 7/4817; G01S 7/4814; G01S 7/4816

(57) ABSTRACT

A LiDAR system includes a first mirror positioned to receive the outgoing light beam from the laser; a second mirror positioned to receive a reflected light beam from the first mirror and to redirect the reflected light beam onto a target, and a detector that detects return light reflected off of the target. The second mirror of the optical periscope includes a cross-sectional area sized and shaped to substantially match a cross-sectional area of the reflected light beam to improve a quality of signal detected by the detector.

### CROSS-REFERENCE TO RELATED APPLICATIONS

This application is a non-provisional application based on and takes priority from pending U.S. provisional application Ser. No. 63/373,678, entitled “Small Aperture Optical Periscope for Lidar,” which was filed on Aug. 26, 2022. The disclosure set forth in the referenced application is incorporated herein by reference in its entirety.

### BACKGROUND

Light detection and ranging (LIDAR) is a technology that measures a distance to an object by projecting a laser toward the object and receiving the reflected laser. In various implementation of LiDAR systems, a light source illuminates a scene. The light scattered by the objects of the scene is detected by a photodetector or an array of photodetectors. By measuring light travel time to and from each object, the distance to various objects in the scene may be calculated.

In a LiDAR system, a laser and detector may be co-located in a same enclosure. To ensure light emitted from the laser strikes the detector after reflecting off a target, the laser and detector may be positioned to respectively transmit and receive parallel light beams and the LiDAR system may include some optical components that redirect light from an emission plane of the laser into a parallel plane that intersects the detector. One way of achieving this type of redirection is to use a periscope. A periscope is an optical instrument that typically includes a set of angled mirrors that are positioned to receive light in a first plane and emit the light in a second plane. The two planes may be parallel or non-parallel to one another, depending upon how they are angled. The use of a periscope in a LiDAR system presents a number of challenges addressed herein.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTION OF THE DRAWINGS

FIG. 1 illustrates an example LiDAR system that uses an optical periscope to route light that is output by a laser in a first plane into a second parallel plane that intersects a target and a detector.

FIG. 2A illustrates components of an example LiDAR system that includes an optical periscope with a secondary periscope mirror obstructing a path of returning light traveling from the target to the detector.

FIG. 2B illustrates components of another example LiDAR system that includes an optical periscope with a secondary periscope mirror of a reduced size as compared to that of FIG. 2A and with dimensions designed to substantially match a cross-sectional profile of a light beam that is to be incident on the secondary periscope mirror.

FIG. 3 illustrates aspects another LiDAR system that uses an optical periscope with primary and secondary mirrors to direct a light beam from a first plane to a second plane parallel to the first plane.

FIG. 4A illustrates an internal scattering effect in a LiDAR system that can diminish detector performance.

FIG. 4B illustrates another example LiDAR system with features that help to reduce the internal scattering effect discussed with respect to FIG. 4A.

FIG. 5 illustrates components of another LiDAR system with an aperture positioned and sized to prevent the internal scattering of outbound light.

FIG. 6 illustrates example operations for assembling a LiDAR system with an optical periscope having a secondary mirror sized to substantially match laser beam size for reduced optical loss.

FIG. 7 illustrates example operations for assembling a LiDAR system with a shield element for preventing internal light reflection by components of an optical periscope

### DETAILED DESCRIPTIONS

An optical periscope may be included in a LiDAR system to redirect light emitted by a laser in a first plane to a second plane. In some systems, certain components of the periscope partially obstruct a path of return light traveling between the target and the detector, reducing the signal received by the detector. The herein disclosed technology provides LiDAR system features that address the foregoing challenges by optimizing the size of an optical component obstructing the light path between the target and detector to substantially match a minimum size needed to support the optical tasks provided by the component.

Another shortcoming addressed by the disclosed technology relates to LIDAR detector signal losses attributable to “internal scattering,” which refers to inadvertent (unintentional) scattering of light internal to the LiDAR unit, such as scattering that occurs when light waves miss a target optical element(s) or strike the corners and or edges of mirrors or other optical or non-optical components. In the specific LiDAR architectures disclosed herein, internal scattering can cause some rays that are supposed to be outbound for the target to instead scatter backward and strike the detector. Since these scattered waves are of an intensity that matches or exceeds the return waves that the detector is designed to measure, the internal scattering effectively ruins any measurements that temporally coincide with the receipt of the scattered waves on the detector. In the case of especially intense internally scattered waves or scattered waves combining with other return light waves, the total intensity of measured light can effectively blind the detector for a brief period of time. This blindness can, in turn, prevent the detector from making critical time-of-flight measurements, particularly the measurements that pertain to regions on the target that are nearest to the detector. The herein disclosed technology provides LiDAR system features that reduce the internal scatter of light by passing an outbound light beam through a small aperture that blocks rays near the edges of the beam before the beam strikes optical components that are proximal to the detector.

The LiDAR system features responsible for the two above-described system improvements (e.g., boosting detected signal via optical component size reduction and directing light through an aperture to reduce internal scattering) are not co-dependent and could be implemented either jointly to effect both improvements in a same system or independently to effect either improvement in isolation.

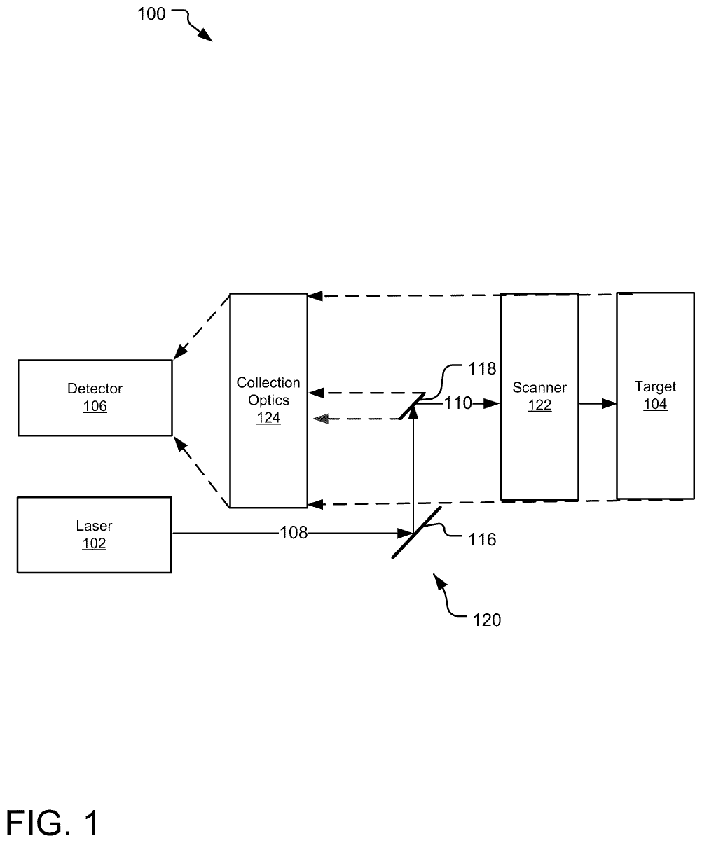

FIG. 1 illustrates an example LiDAR system 100 that uses an optical periscope 120 to route light that is output by a laser 102 in a first plane 108 into a second parallel plane 110 that intersects a target 104 and a detector 106. The optical periscope 120 includes a primary mirror 114 and a secondary mirror 118. Although other implementations are contemplated, the primary mirror 116 and the secondary mirror 118 are, in FIG. 1, both angled at 45 degrees with reflective surfaces facing opposite directions such that primary mirror 116 redirects light from the laser 102 to the secondary mirror 118, and the secondary mirror 118 redirects the light onto a scanner 122 that controllably directs (e.g., steers) the outbound light beam onto a target 104. For example, the scanner may controllably sweep a beam of pulsed light emitted by the laser 102 across rows and/or columns on the target 104. The pulses of light striking different portions of the target 104 are reflected back toward the detector 106 in a direction antiparallel to emitted light, intersecting collection optics 124 that focus the return signal on the detector 106.

In one implementation, the scanner 122 may include various components designed to ambulate the pulsed light beam in different ways, such as by moving mirrors or other optical components and/or with using solid state (non-moving) components that steer the light by controllably altering its phase, such as by controllably altering voltages applied to cells that receive and reflect the incident light to change their indices of refraction.

In some implementations, the light emitted from the laser 102 is coherent light that is modulated in some way prior to being sent through the scanner 1022. For example, the light may be modulated by way of a continuous frequency shift or a pseudo-random binary sequence (PRB S) pattern encoded on the phase by a modulator (not shown) prior to being sent through the scanner 122. In these cases, the pattern observed in the return signal may then be mapped to the corresponding pattern in the original signal to extract the time-of-flight measurements for each pulse. The LiDAR system 100 may include a number of optical components in addition to or in lieu of some components shown that are readily understood known in the field of LiDAR technology.

Since the secondary mirror 118 is in the optical path of return light traveling from the target 104 to the detector 106, it is beneficial to make this mirror as small as possible to reduce optical loss of the system. In one implementation, the secondary mirror 118 of the LIDAR system 100 has a cross-sectional area sized and shaped to substantially match a cross sectional area of a light beam from the laser that strikes the secondary mirror 118. As used herein, “substantially match” refers to a dimensional match that is within +/−10% of an exact match. For example, the light beam received at the secondary mirror may be of a same shape as the light beam that it receives and have a height and width that substantially match corresponding dimensions of the received light beam. In one implementation, the secondary mirror 118 has a cross-sectional profile slightly bigger than a corresponding cross-sectional profile of the light beam, such as about 10% larger to ensure that all light from the light beam strikes the secondary mirror 118 and also that the mirror is big enough to remove unwanted in-LiDAR reflections.

Sizing the secondary mirror 118 to be as small as possible mitigates optical loss that may otherwise be observed due to the presence of the secondary mirror 118 in the path of return light traveling between the target 104 and the detector 106. In this case, “as small as possible” is intended to imply that the mirror is still large enough to serve the function of redirecting all light that is of high enough intensity to trigger a detection on the detector 106 into the secondary plane 110 and toward the target.

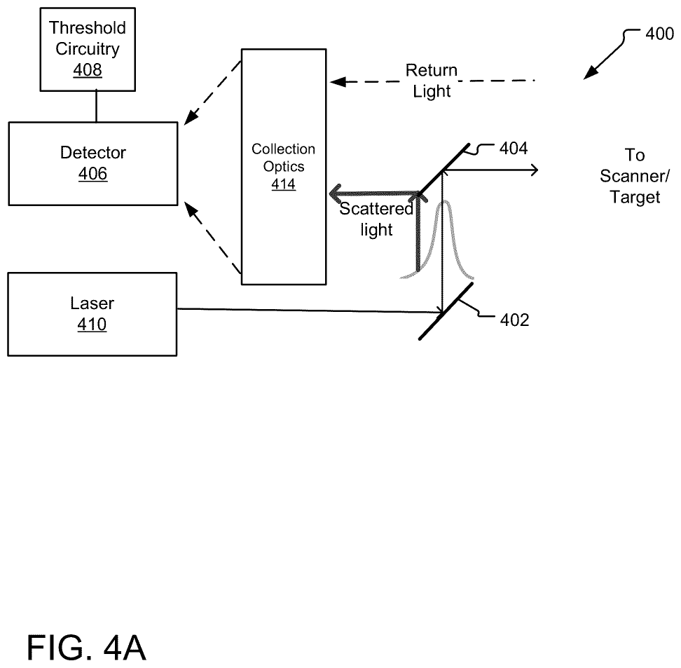

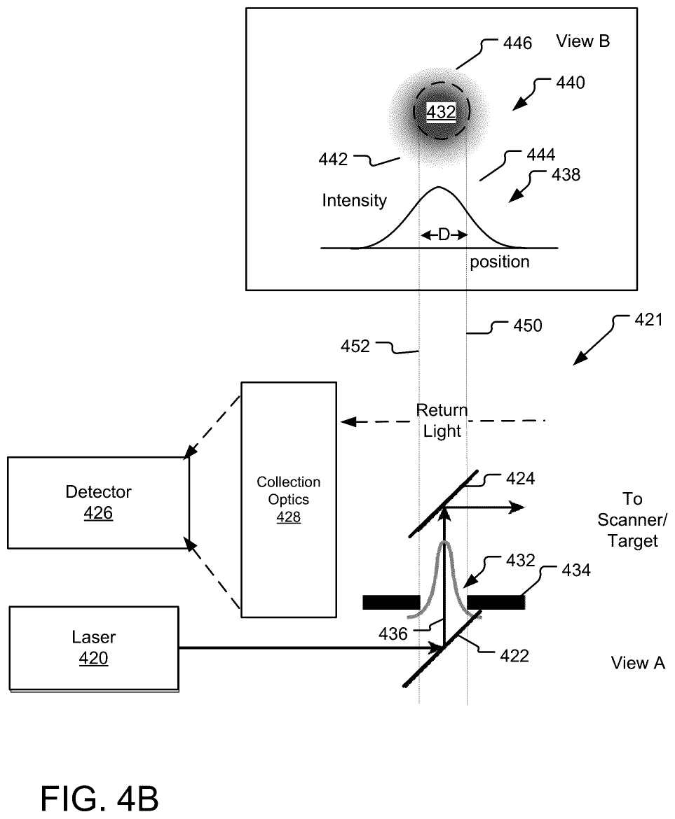

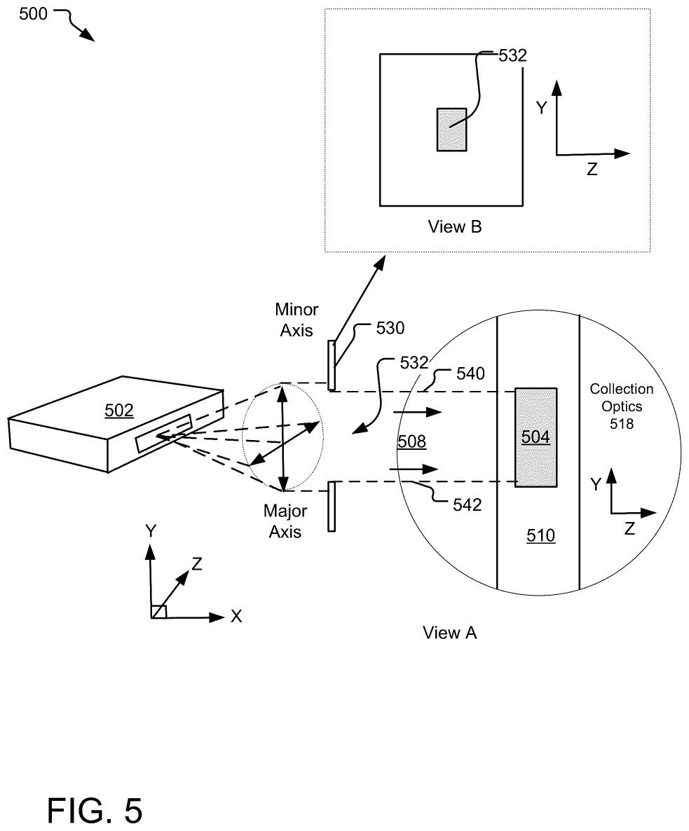

In some implementations, the LiDAR system 100 additionally includes an aperture between the primary mirror 116 and the secondary mirror 118 that is designed to receive the light beam and prevent a predefined portion of the light near the edges of the beam from reaching the secondary mirror 118. This addresses the problem of internal scattering and is discussed in greater detail with respect to FIGS. 4 and 5.

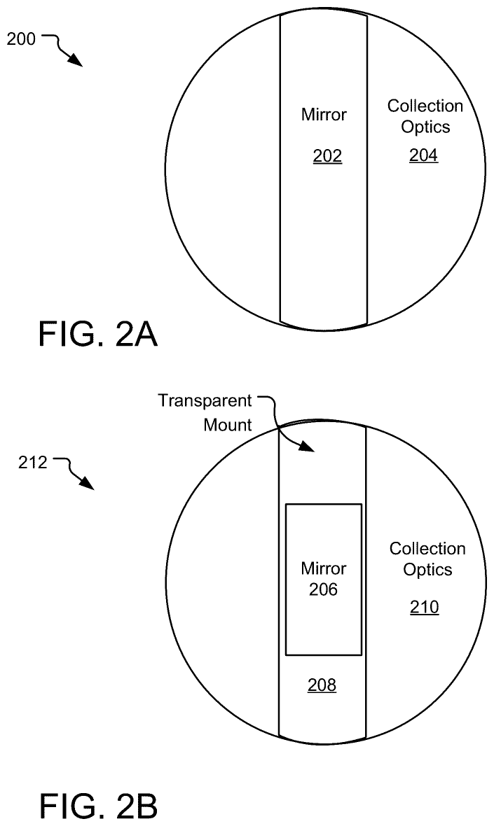

FIG. 2A illustrates components of an example LiDAR system 200 that includes an optical periscope with a secondary periscope mirror 202 obstructing a path of returning light traveling from a target (not shown) to a detector (not shown). In this implementation, the secondary periscope mirror 202 that does not have dimensions designed to substantially match a cross-sectional profile of a laser beam directed through the optical periscope. Although not shown in full, the LiDAR system 200 may have the same structural components as those shown and described with respect to FIG. 1 including an optical periscope that includes the secondary periscope mirror 202 as well as a primary periscope mirror (not shown). The mirrors of the optical periscope are, in one implementation, positioned as shown in FIG. 1 with respect to other system components.

In the view of FIG. 2A, collection optics 204 are visible behind the secondary periscope mirror 202. The vantage point shown in FIG. 2 corresponds to a line-of-sight view along the plane 110 of FIG. 1 from a position between the target 104 and the secondary mirror 118 looking toward detector 106.

In this implementation, the secondary periscope mirror 202 is a long reflective strip designed to receive a light beam from a primary periscope mirror (not shown) and to reflect this light beam toward a target, such as in the arrangement of FIG. 1. The secondary periscope mirror 202 is considerably larger in length and also in width than a size of the light beam that it receives from the primary periscope mirror (not shown). When the light leaving the optical periscope strikes the target, the return light is reflected back in the opposite direction toward the collection optics, and the secondary periscope mirror 202 directly obstructs this path. Due to the large size of the secondary periscope mirror 202 (e.g., relative to the implementation shown in FIG. 2B, discussed below) the LiDAR system 200 suffers significant optical loss.

In one example, FIG. 2B illustrates components of another example LiDAR system 212 that includes an optical periscope with a secondary periscope mirror 206 of a reduced size as compared to that of FIG. 2A and with dimensions designed to substantially match a cross-sectional profile of a light beam that is to be incident on the secondary periscope mirror 206 when outbound from the LiDAR system in route to a target (3D scene). Again, the LiDAR system 212 may be understood as having the same structural components as those shown and described with respect to FIG. 1 including an optical periscope that includes the secondary periscope mirror 206 as well as a primary periscope mirror (not shown). The mirrors of the optical periscope are, in one implementation, positioned as shown in FIG. 1 with respect to other system components. The view of FIG. 2B corresponds to the same vantage point line-of-sight as that shown with respect to FIG. 2A.

However, the LiDAR system 212 of FIG. 2B differs from the LiDAR system 200 of FIG. 2A in that the secondary periscope mirror 206 is a small reflective patch on a transparent mount 208. The transparent mount 208 is transparent to light emitted by the light source in the LiDAR system 212. In one implementation, the transparent mount 208 is coated with an anti-reflective material designed to be transparent to the wavelength of the light emitted by the laser 102. As compared to the design of FIG. 2A, the design of FIG. 2B, the reduced size of the secondary periscope mirror 206 of FIG. 2B as compared to the secondary periscope mirror 202 of FIG. 2A permits a much greater amount of the light reflected off of the target is make it past the secondary periscope mirror 206 and to the collection optics 210 that focus the light on the detector.

The transparent mount 208 is, for example, a transparent substrate that supports and suspends the secondary periscope mirror 202 at a target position relative to other optics in the LiDAR system. In one implementation, the transparent mount 208 is a glass substrate with an antireflective coating (e.g., single or alternating layers of silicon oxide and magnesium fluoride or other materials with similar properties). The secondary periscope mirror 206 includes a reflective layer such as silver, tin, nickel, chromium, or aluminum that is deposited by wet process, sputtering, or evaporation in a vacuum. In one implementation, the secondary periscope mirror 206 is formed separately from the underlying transparent mount 208 and is attached to the transparent mount 208 by an adhesive. For example, the secondary periscope mirror 206 is formed on its own substrate (to ensure it is adequately “flat”) and then attached to the transparent mount 208 via the adhesive, which may be a dual-sided sticker, glue, or other adhesive material.

In one implementation, the transparent mount 208 includes a transparent substrate with an optical filter that transmits the wavelength of light emitted by the laser 102. The optical filter may be a dielectric coating that includes alternating layers of two or more dielectric materials having different refractive indices. The optical filter may be a band-pass optical filter that (i) transmits light over a pass-band wavelength range that includes the wavelength of light emitted by the laser 102 and (ii) blocks (e.g., reflects or absorbs) light at wavelengths outside of the filter pass-band. For example, the laser 102 may emit light at 1550 nm, and the transparent mount 208 may be coated with a band-pass optical filter that (i) is anti-reflective and transmits light between approximately 1548 nm and approximately 1552 nm and (ii) reflects or absorbs light at wavelengths less than approximately 1548 nm and greater than approximately 1552 nm. The band-pass optical filter may transmit greater than 90% of light between 1548 nm and 1552 nm. Additionally, the band-pass optical filter may block greater than 90% of light between approximately 1000 nm and approximately 1547 nm and may block greater than 90% of light between approximately 1553 nm and approximately 1700 nm. The transparent mount 208 may not be limited to a strip of material as illustrated in FIG. 2B. Rather, the transparent mount 208 may extend to encompass the region of the collection optics 210 so that any received light that is directed to the detector 106 first passes through the band-pass optical filter. In this configuration, the band-pass optical filter may prevent unwanted light from reaching the detector 106. For example, the optical filter may transmit light from the laser 102 that is reflected by the target 104 while substantially blocking sunlight, light from car headlights, or light from other LiDAR systems operating at different wavelengths.

In FIG. 2B, the secondary periscope mirror 206 is shown to be rectangular. In other implementations, the secondary periscope mirror 206 is shaped differently (e.g., elliptical). Ideally, the shape of the secondary periscope mirror 206 substantially matches the shape of the laser beam that is to be received and reflected by the secondary periscope mirror 206. The patch is sized to have cross-sectional dimensions (e.g., height/width) that substantially match the laser beam that is to be received on the secondary periscope mirror 202. For example, the cross-sectional dimensions of the secondary periscope mirror 206 may be chosen to match the dimensions of the laser beam emitted by the LiDAR light source or, if this beam is to be altered in size or shape by LiDAR optics prior to exiting the optical periscope, the secondary periscope mirror may have cross-sectional dimensions that match those of laser beam at the time the beam is received at the secondary periscope mirror 206.

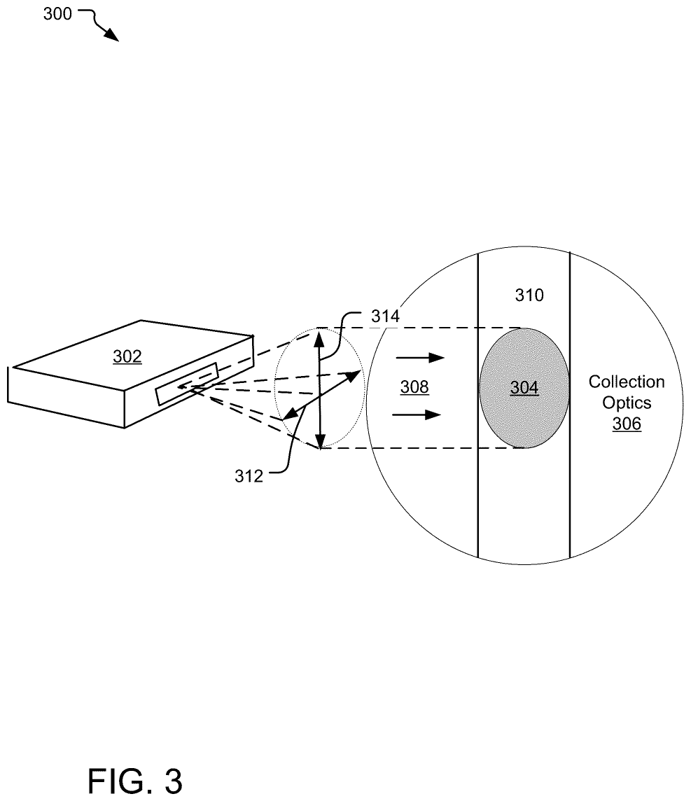

FIG. 3 illustrates aspects another LiDAR system 300 that uses an optical periscope with primary and secondary mirrors to direct a light beam from a first plane to a second plane parallel to the first plane. The view of FIG. 3 does not illustrate a full optical periscope or complete LIDAR system but instead shows a light source 302 (e.g., a laser) and features of the light source 302 relative to a secondary periscope mirror 304 and collection optics 306. In one implementation, the light source 302, secondary periscope mirror 304, and collection optics 306 are arranged relative to one another in a configuration and system the same or similar to those described above with respect to FIGS. 1, 2A, and 2B.

The light source 302 emits a light beam 308 that has a major axis 314 and a minor axis 312 as shown. In FIG. 3, the emitted light beam is elliptical; however, beam shape may vary along with the type of light source incorporated into the LiDAR system 300. For simplicity and illustration of concept, the light beam 308 is shown being directed onto the secondary periscope mirror 304; however, it is to be understood that the light beam 308 may interact with other optical elements of the LiDAR system 300 before reaching the secondary periscope mirror 304.

In one implementation, the light beam 308 is directed onto a primary periscope mirror (not shown) of an optical periscope which, in turn, redirects the light onto the secondary periscope mirror 304. The secondary periscope mirror 304 is attached to (e.g., formed on) a transparent mount 310, such as a glass substrate coated with a material that is antireflective to the laser light. The secondary periscope mirror 304 has a shape that matches that of light beam 308 (e.g., elliptical) and a cross-sectional area with dimensions that also substantially match that of the light beam 308. As such, the secondary periscope mirror 304 is effectively as small as it possibly can be while still being large enough to redirect substantially all (e.g., such as 99.99% or greater) of the light that it receives onto the target of the LiDAR system, ensuring that the system detector does not detect any spurious light from the outgoing light beam 308. The small size of the secondary periscope mirror 304 helps to improve the strength (quality) of the return signal received at the detector (not shown).

FIG. 4A illustrates an internal scattering effect in a LiDAR system 400 that can diminish detector performance. The LiDAR system 400 includes a laser 410 that directs a light beam into an optical periscope with a pair of mirrors 402, 404 angled to redirect the light from a first plane of the laser 410 to a second parallel plane. Light exiting the optical periscope is controllably directed (e.g., by a scanner) onto a target (not shown). After striking the target, return light is reflected back to the collection optics 414 that focus the light onto the detector 406.

One common way for LiDAR systems to detect the return light is to transmit powerful, short pulses of light from the laser 410 and utilize a detector with sensitive photodiodes, such as avalanche photodiodes (APDs). In some systems, the detector 406 has an output connected to threshold circuitry 408 that transmits a “HIGH” signal if the signal on the detector 406 surpasses a given expected threshold (e.g., has an intensity or luminosity that exceeds the range that the detector 406 is optimized for). If the detector 406 receives a bright pulse of light that triggers the “HIGH” signal output from the threshold circuitry 408, this may indicate that the detector 406 has been saturated with light and temporarily blinded in that the detector 406 is unable to make a detection for some amount of dead time. This dead time is induced because the pulse of light has a finite width, and also because the electronic transitions within the detector 406 (conversions of detected light into electricity) do not happen instantaneously. In some implementations, the amount of dead time that results from the above effect can translate to several meters of range in which the detector 406 is temporarily blinded and cannot make a detection. It is therefore desirable to try to prevent inadvertent saturations of the detector 406.

In the architecture of the LiDAR system 400, the power of the outgoing transmitted laser light may be many orders of magnitude greater than the minimum return signal that the detector 406 is optimized to detect. Therefore, if even a small fraction of light from an outgoing laser pulse scatters onto the detector 406, this can be enough to temporarily blind the LiDAR system for several meters of detection before the detector 406 recovers. In this scenario, the detector 406 may “miss” waves of the return light from the pulse that bounce off of nearby objects in the scene.

Notably, a laser beam's spatial profile generally tapers off rather than having a well-defined shaped, and there can be often enough energy quite far from the center of the laser beam to blind the detector 406. Within the LiDAR system 400, it is therefore possible for outgoing laser light to scatter off of the edges of a secondary periscope mirror 404 within the optical periscope and/or to miss the secondary periscope mirror 404 entirely and strike other components within an enclosure of the LiDAR system 400 that, in turn, re-scatter the light until it inadvertently strikes and blinds the detector 406. This undesirable scattering of light off of the secondary periscope mirror 404 is illustrated in FIG. 4A.

FIG. 4B illustrates another example LiDAR system 421 with features that help to reduce the internal scattering effect discussed with respect to FIG. 4A. The LiDAR system of FIG. 4B includes the same components as those shown and described above with respect to FIG. 4A including a laser 420 that directs a light beam 436 into an optical periscope that, in turn, redirects the light from a first plane of the laser 420 to a second parallel plane that intersects a detector 426. The LiDAR system 421 of FIG. 4B differs from that of FIG. 4A in that it additionally includes a shield element 434 with a small aperture 432 between a primary mirror 422 and a secondary mirror 424 of the optical periscope. The shield element 434 is, for example, a non-transparent planar component with the aperture 432 (e.g., a pinhole) aligned with the light beam 436 that is reflected off the primary periscope mirror 222. In one implementation, the aperture 432 is sized to be just smaller than the light beam 436 so as to block a predefined portion of the light from the edges of the light beam 436 so as to ensure that light does not scatter off the edges of the secondary periscope mirror 424.

In one implementation, the light beam 436 is a coherent light beam with an intensity that is highest near the center of the beam, as generally indicated by the darker shading shown in cross sectional beam profile 440 of in View B. The light beam 436 has an intensity profile described by a Gaussian function 438 with a peak corresponding to a center of the light beam 436, as shown. The aperture 432 is sized to ensure that the shield element 434 blocks light of the light beam 436 that is within a defined cutoff region (e.g., external to cutoff perimeter 446) corresponding to the tails of the Gaussian function 438. By example, FIG. 4 illustrates this cutoff region as including light external to boundaries 442, 444 of the Gaussian function 438.

Notably, the light beam 436 may expand somewhat as it traverses its outbound path through the LiDAR system 421. The degree of this expansion is subtle, and can be readily determined by one of skill in the art. Although some implementations may provide for locating the aperture 432 elsewhere in the LiDAR system 421, such as just before the light beam 436 reaches the primary mirror 422, a more precise tuning of the cutoff perimeter 446 can be achieved when the aperture 432 is positioned as shown between the primary mirror 422 and the secondary mirror 424.

In one implementation, the predefined cutoff region (e.g., the region outside of the cutoff perimeter 446) includes light that is positionally offset by greater than three sigma from the beam center. For example, 99.7 percent of the light in the light beam 436 passes through the aperture 432 in the shield element 434 and 0.03 percent of light is blocked. In another implementation, the light within this predefined cutoff region is at or greater than four sigma from the beam center, in which case 99.99 percent of the light beam 436 still passes through the aperture but 0.01 percent of the light is blocked. Since the aperture 432 is designed to block such a small percentage of the light wave in the light beam 436, the intensity of light focused onto the detector 426 by the collection optics 428 is not significantly altered.

In one implementation, the size of the aperture 432 is optimized by maximizing Signal=(Atotal−Aperiscope(aperture))*P(aperture) with respect to an unknown value for “aperture,” where Atotal is the total cross-sectional area of the receive light path, P(aperture) is a function of transmit power that depends upon the size of the aperture, and Aperiscope(aperture) is the periscope size, which is also a function of the aperture size.

The secondary mirror 424 is sized to be longer than the aperture and to have opposing ends that extend beyond parallel axes 450, 452 that are tangent to corresponding opposing edges of the aperture 432. This relative sizing ensures that edges rays of the light beam 436 do not scatter off the edges of the secondary mirror 424.

In implementations, the aperture 432 may be engineered in size and shape to ensure that the reduction in light intensity (power) across the aperture 432 is less than a predefined threshold, such as less than 1% of the light. According to one implementation, the aperture 432 has the effect of blocking light outside of 3 sigma from the beam center, and this effectively reduces the intensity of light detected by the LiDAR system 421 by less than 0.3% percent. Other implementations may have specifications that vary from these values, blocking more or less light from the perimeter of the light beam, but that are still effective to improve performance of the system 400 as otherwise consistent with the examples herein.

However, since the light at the edges of the light beam 436 is blocked by the shield element 434, the scattering of laser light toward off of the secondary mirror 424 and toward the detector 426 is substantially prevented and the detector 426 is not inadvertently blinded by this scattering.

FIG. 5 illustrates components of another LiDAR system 500 with an aperture 532 positioned and sized to prevent the internal scattering of outbound light. The aperture 532 is formed in a shield element 530 and substantially aligned with a center of a light beam 508 emitted by a laser 502. In one implementation, the shield element 530 is positioned between a primary mirror (not shown) and a secondary mirror 504 of an optical periscope, such as in the manner and system shown with respect to FIG. 4B. The primary mirror is omitted in FIG. 5 to help illustrate a relative size and shape of the light beam 508 emitted by the laser 502 relative to the secondary mirror 504.

In the implementation shown, the secondary mirror 504 is a small reflective patch formed on a transparent mount 510. The secondary mirror 504 may have a cross-sectional area sized and shaped to substantially match a cross-sectional area of the light beam 508 (reflected off of the primary mirror) that it receives through the aperture 532, such as in the manner described with respect to FIG. 1-3 above.

In FIG. 5, the aperture 532 is sized and shaped to block a predefined portion of the light from the edges of the light beam 508 that corresponds to a predefined cutoff region within tails of a Gaussian distribution describing the light beam that strikes the optical shield 530, such as in the manner shown and described with respect to FIG. 4B. Sizing of the aperture 532 in this way narrows the light beam 508 that reaches the secondary mirror 504 without blocking a substantial portion of the beam's power. Therefore, an intensity of return light reaching a system detector (not shown) remains substantially unchanged (e.g., includes >99% of the original beam light) by the addition of the optical shield 530 and aperture 532. At the same time, however, the physical dimensions of the beam are narrowed, which prevents internal scattering of the light off of the edges of the secondary mirror 504 or other optical elements. In addition, the narrowing of the light beam 508 incident on the secondary mirror 504 may beneficially allow for a slight further reduction in the dimensions of the secondary mirror 504.

As discussed elsewhere herein, optical losses proportional to the size of the secondary mirror 504 may be observed in implementations where the secondary mirror 504 obstructs a path of return light traveling from an imaging target to collection optics 518 that focus the light on a detector (not shown). For this reason, even small reductions in the size of the secondary mirror can yield a significant improvement in the intensity of the return light signal received at the detector. To leverage this effect, the secondary mirror 504 is, in some dimensions, sized to substantially match or just slightly exceed the dimensions of the aperture 532.

In one implementation, the secondary mirror 504 is sized just bigger than the aperture, such as 5-10% larger in each dimension. Nominally, the secondary mirror 504 and the aperture 532 could have identical dimensions; however, making the secondary mirror 504 just slightly larger provides a margin of error that is more forgiving of slight alignment errors and diverging optical diffraction from the edges of the aperture. In FIG. 5, the secondary mirror 504 is shown to be just larger than the aperture 532 such that the aperture is defined by a pair of opposing edges tangent to a pair of parallel axes that intersect the second mirror (e.g., axes 540 and 542), thereby ensuring that none of the light in the light beam 508 incident on the secondary mirror 504 is scattered off the edges of the secondary mirror 504.

In the LiDAR system 500, the aperture has a rectangular shape, as visible in View B (a head-on view 90 degrees different from the cross-sectional profile of the aperture 532 visible in View A). In this system, the beam initially emitted by the laser 502 has an elliptical profile. Therefore, the shape of the light beam 508 changes from elliptical to rectangular as it passes through the rectangular aperture.

Notably, the use of a rectangular aperture with an elliptical laser beam is a matter of design choice and other implementations may provide for use laser beams, apertures, and receiving optical elements (e.g., secondary periscope mirrors) of other shapes the same or different from one another. In one implementation, the laser 502 emits an elliptical laser beam and the aperture 532 and the secondary mirror 504 are both elliptical to generally match the shaped of the beam. The design of FIG. 5 with the rectangular aperture may notably be easier to manufacture than designs with elliptical apertures. In general, apertures of any shape can be tuned in size relative to the size of shape of a received laser beam to block light within a targeted cutoff frequency range (e.g., outside three sigma from the beam center).

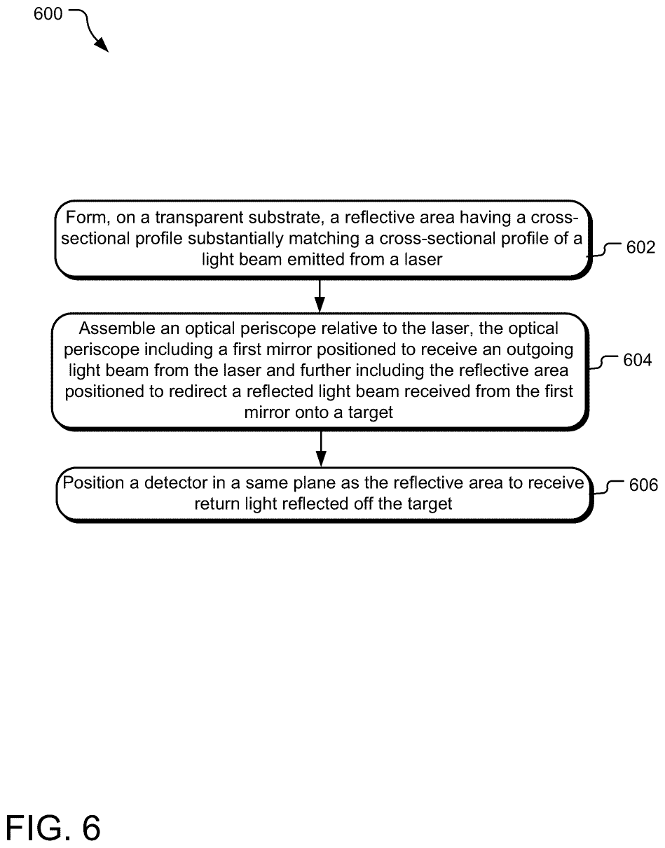

FIG. 6 illustrates example operations 600 for assembling a LiDAR system with an optical periscope having a secondary mirror sized to substantially match laser beam size for reduced optical loss. The method includes a formation operation 602 that provides for forming, such as through a deposition operation, a reflective area on a transparent substrate. In one implementation, reflective area has a cross-sectional profile that substantially matches a cross-sectional profile of an outgoing light beam emitted from a laser in a LiDAR system. An assembling operation 604 assembles an optical periscope to be positioned relative to the laser such that a primary mirror of the optical periscope is positioned to receive the outgoing light beam from the laser and to redirect the outgoing light beam (e.g., as the reflected light beam) onto the reflective area. In this implementation, the reflective area functions as a secondary mirror of the optical periscope and is positioned to redirect the reflected light beam received form the first mirror onto a target. Another positioning operation 606 positioned the detector within a plane of the secondary mirror to receive return light reflected off the target.

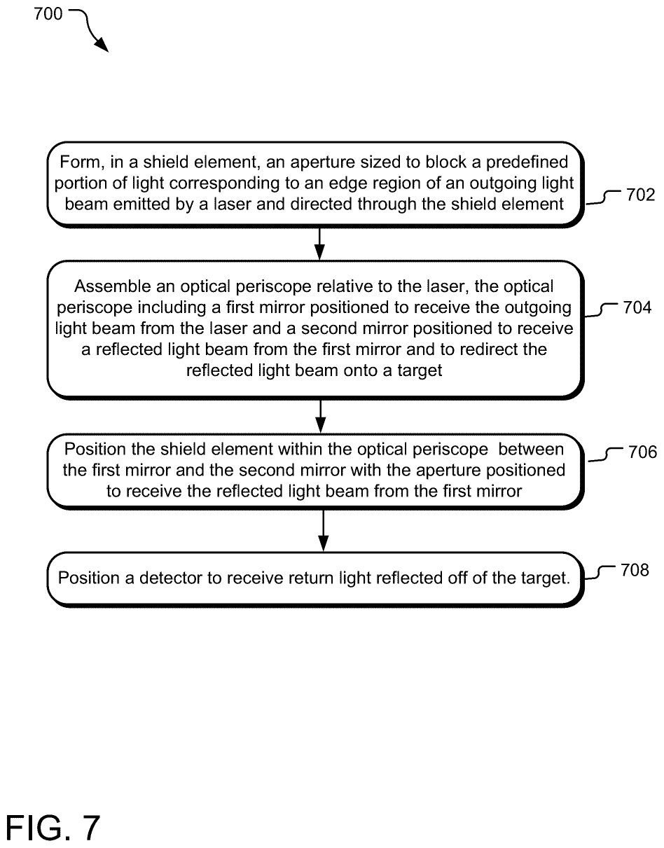

FIG. 7 illustrates example operations 700 for assembling a LiDAR system with a shield element for preventing internal light reflection by components of an optical periscope. A formation operation 702 forms, in the shield element, an aperture sized to block a predefined portion of light corresponding to an edge region of a light beam emitted by a laser. An assembling operation 704 assembles an optical periscope relative to the laser to redirect an outgoing light beam of the laser onto a target. The optical periscope includes a first mirror and a second mirror. The first mirror is positioned to receive the outgoing light beam from the laser, and the second mirror is positioned to receive a reflected light beam from the first mirror and to redirect the reflected light beam onto the target. An insertion operation 706 inserts the shield element between the first mirror and the second mirror with the aperture positioned to receive the reflected light beam from the first mirror. A positioning operation 708 positions a detect to receive return light reflected off of the target.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A LiDAR system including:
a laser positioned to transmit an outgoing light beam;
an optical periscope including:
a first mirror positioned to receive the outgoing light beam from the laser;
a second mirror positioned to receive a reflected light beam from the first mirror and to redirect the reflected light beam onto a target, the second mirror having a cross-sectional area sized and shaped to substantially match a cross-sectional area of the reflected light beam; and
a detector that detects return light reflected off of the target.

2. The LiDAR system of claim 1, wherein the second mirror is a reflective patch on a transparent substrate.

3. The LiDAR system of claim 2, wherein the transparent substrate includes a coating that is anti-reflective to light emitted by the laser.

4. The LiDAR system of claim 2, wherein the transparent substrate includes a band-pass optical filter that (i) transmits light over a pass-band wavelength range that includes a wavelength of light emitted by the laser and (ii) blocks light outside of the pass-band wavelength range.

5. The LiDAR system of claim 2, where the return light travels in a direction antiparallel to the outgoing light beam.

6. The LiDAR system of claim 2, wherein the return light passes through the transparent substrate in route to the detector.

7. The LiDAR system of claim 1, wherein the second mirror prevents a portion of the return light from reaching the detector.

8. The LiDAR system of claim 1, wherein the laser and the first mirror are aligned along a first axis and the detector and the target are aligned along a second axis, the second axis being parallel to the first axis.

9. The LiDAR system of claim 8, further comprising collection optics positioned to intersect the second axis between the second mirror and the detector, the return light passing through the collection optics in route to the detector.

10. The LiDAR system of claim 1, wherein the optical periscope further includes an aperture located between the first and second mirrors, wherein the aperture is positioned to receive the reflected light beam from the first mirror, and the aperture is sized to block a predefined portion of the light from edges of the reflected light beam.

11. A method for improving signal quality in a LiDAR system, the method comprising:
directing an outgoing light beam onto a first mirror of an optical periscope;
redirecting, by a second mirror or the optical periscope, a reflected light beam received from the first mirror onto a target, the second mirror having a cross-sectional area sized and shaped to substantially match a cross-sectional area of the reflected light beam; and
detecting, by a detector, return light reflected off the target.

12. The method of claim 11, wherein the second mirror is a reflective patch on a transparent substrate.

13. The method of claim 12, wherein the transparent substrate includes a coating that is anti-reflective to a wavelength of the outgoing light beam.

14. The method of claim 13, wherein the return light travels in a direction antiparallel to the outgoing light beam.

15. The method of claim 12, wherein the return light passes through the transparent substrate in route to the detector.

16. The method of claim 12, wherein the second mirror prevents a portion of the return light from reaching the detector.

17. The method of claim 12, wherein a laser and the first mirror are aligned along a first axis and the detector and the target are aligned along a second axis, the second axis being parallel to the first axis.

18. The method of claim 17, wherein the return light passes through collection optics positioned to intersect the second axis between the second mirror and the detector.

19. A method for assembling a LiDAR device, the method comprising:
forming, on a transparent substrate, a reflective area having a cross-sectional profile substantially matching a cross-sectional profile of a light beam emitted from a laser;
assembling an optical periscope relative to the laser, the optical periscope including a first mirror positioned to receive an outgoing light beam emitted from the laser and further including the reflective area positioned to redirect a light beam reflected from the first mirror onto a target; and
positioning a detector to receive return light reflected off of the target.

20. The method of claim 19, wherein the laser and the first mirror are aligned along a first axis and the detector and the target are aligned along a second axis, the second axis being parallel to the first axis.

21. The method of claim 19, further comprising: coating the transparent substrate with a coating that is anti-reflective to a wavelength of light emitted by the laser.

22. The method of claim 19, wherein the return light passes through the transparent substrate in route to the detector the return light and travels in a direction antiparallel to a direction of the outgoing light beam.
